(19) United States
(12) Patent Application Publication
(10) Pub. No.: US 2007/0225416 A1
(43) Pub. Date: Sep. 27, 2007

(54) FLAME RETARDANT POLYCARBONATE COMPOSITIONS HAVING GOOD TRANSPARENCY AND LOW HAZE, METHOD OF MANUFACTURE, AND ARTICLES PREPARED THEREFROM

(75) Inventors: Rein Mollerus Faber, Bergen op Zoom (NL); Chiel Albertus Leenders, Fijnaart (NL)

Correspondence Address: GEAM - LEXAN;IP LEGAL, ONE PLASTICS AVE., PITTSFIELD, MA, 01201-3697, US

(73) Assignee: General Electric Company, Schenectady, NY (US)

(21) Appl. No.: 11/277,274

(22) Filed: Mar. 23, 2006

(51) Int. Cl. C08K 5/41

(52) U.S. Cl. 524/155; 524/611

(57) ABSTRACT

A composition is disclosed, comprising a polycarbonate resin and a flame retardant additive comprising a lithium salt, wherein an article prepared from the composition has a haze value less than about 1% as measured at a thickness of about 5.0 mm according to ASTM D1003 and wherein the composition is substantially chlorine and bromine free.

### BACKGROUND OF THE INVENTION

This application relates to flame retardant polycarbonate compositions, and in particular to flame retardant polycarbonate compositions having good transparency and low haze, methods of manufacture, and uses thereof.

Polycarbonates are a type of thermoplastic that are often used for applications in which good impact strength, low haze and high transparency are desired. For example, certain thermoplastic parts of vehicles are often made from polycarbonates. For many applications, polycarbonates must have fire retardant properties. It is known to add chlorinated or brominated flame retardant additives to the composition to prepare fire retardant polycarbonate compositions. For example low molecular weight brominated bisphenol A polycarbonate is often used to render polycarbonate compositions flame retardant while retaining transparency. In the event of a fire however, compositions with brominated or chlorinated flame retardant additives may release toxic gases that upon inhalation can cause bodily harm. Therefore there is a legislative trend to require materials for critical applications to be substantially chlorine and bromine free. Environmental groups have also raised concerns about the long-term effects of disposal of chlorine and bromine containing materials in the environment. Both of these have led to a desire for new, substantially chlorine and bromine free materials.

Fire retardant polycarbonate compositions without brominated or chlorinated additives have been known in the art. Typically these compositions contain a potassium or sodium salt of a sulfonate or sulfone sulfonate to make the composition self-extinguishing. Examples of flame retardant salts known in the art are potassium perfluorobutane sulfonate (Rimar salt and potassium diphenylsulfone sulfonate (KSS). In addition to the flame retardant salts, anti-drip agents are often added to reduce ‘burning’ drip. “Burning drip” is a term that refers to flaming molten drips of plastic that can fall from a burning piece of plastic and serve as a second ignition source. Anti-drip agents reduce this phenomenon. Unfortunately, polycarbonate compositions containing the aforementioned flame retardant salts typically lack clarity and transparency. Particularly at higher levels of flame retardant salts, such compositions are hazy. Also, compositions containing the aforementioned flame retardant salts can cause visible bubbles when used to injection mold thicker parts, e.g. thicker than 4 mm, creating aesthetics problems.

U.S. Pat. No. 6,730,720 to Gohr et al. discloses a method to reduce haze in the production of fire resistant polycarbonate compositions comprising flame retardant salts. Specifically, they disclose blending the salt with a first polycarbonate to form a concentrate, and subsequently adding the concentrate to a second polycarbonate resin. As an example 0.1% by weight of potassium perfluorobutane sulfonate in polycarbonate is disclosed. This method has the disadvantage of requiring two steps. Moreover, despite accomplishing a haze improvement (from 1.9% to 0.9% @3.2 mm), thicker parts (i.e., >4mm) still show significant haze. U.S. Pat. No. 4,735,978 (Ishihara) discloses a flame retardant polycarbonate composition comprising bisphenol A polycarbonate, an ortho-methyl-substituted aromatic dihydroxy compound (2,2-bis (4-hydroxy-3,5-dimethylphenyl) propane) and a flame retardant salt (KSS), but it does not mention the transparency and haze of these compositions.

Hence there is a need for easy to prepare substantially chlorine and bromine free flame retardant polycarbonate compositions having excellent transparency, low haze and no bubble formation upon molding.

### SUMMARY OF THE INVENTION

In an embodiment, the above requirements are met by a composition comprising a polycarbonate resin and a lithium-containing flame retardant salt and wherein an article prepared from the composition has a haze value of less than 1% when measured on a 5 mm thick color plaque according to ASTM D1003. In one embodiment the flame retardant salt is a lithium perfluoroalkane sulfonate. In a preferred embodiment the flame retardant salt is present at a level between 0.06 and 0.3% by weight of the total composition.

In another embodiment, a method comprises preparing a composition by melt blending a mixture comprising a polycarbonate resin and a lithium containing flame retardant salt and subsequently forming the composition into an article, wherein the article has a haze value of less than 1% when measured at a thickness of 5 mm according to ASTM D1003.

In another embodiment, a substantially chlorine and bromine free flame retardant polycarbonate composition is prepared using a lithium containing flame retardant.

Molded articles may be prepared from the above-described compositions.

### BRIEF DESCRIPTION OF THE FIGURES

FIG. 1 is a graphic representation of the measured amount of potassium perfluorobutane sulfonate (K-PFBS) in comparative examples 1, 2 and 3 (Table 2) versus the formulated amount.

FIG. 2 is a picture showing bubble formation in injection molded thick articles.

### DETAILED DESCRIPTION OF THE INVENTION

Applicants have found that lithium salt flame retardants produce superior clarity and transparency polycarbonate compositions when compared to otherwise similar compositions containing equivalent potassium or sodium salts. Further, such compositions do not produce ‘bubble formation’ when molding thicker parts. Therefore, relatively higher levels of the lithium salt flame retardants can be used to obtain the desired flame retardant performance without negatively affecting the transparency and physical properties of the polycarbonate.

For the purpose of this disclosure ‘substantially chlorine and bromine free’ means that the combined total amount of molecular chlorine plus bromine is less than 0.2 wt % as according to and measured by DIN/VDE 0472 part 815 Polycarbonate resin may contain trace amounts of chlorine or bromine, particularly chlorine, due to the presence of residues of compounds used in the manufacturing process. For example catalyst residues, residues of the carbonate precursor, or residues of halogenated solvents (e.g., methylene chloride and monochloro benzene) may leave trace amounts of chlorine. Typically those halogenated solvents may be present at levels between 0.1 parts per million (ppm) and a few hundred ppm.

As stated above, the thermoplastic composition comprises a polycarbonate. As used herein, the terms “polycarbonate”, “polycarbonate composition”, and “composition comprising aromatic carbonate chain units” includes compositions having structural units of the formula (1): 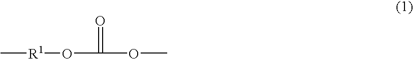
wherein greater than or equal to about 60 percent of the total number of R¹ groups are aromatic organic radicals and the balance thereof are aliphatic, alicyclic, or aromatic radicals. Specifically, R¹ is an aromatic organic radical and, more specifically, a radical of the formula (2):
—A¹—Y¹—A²— (2)
wherein each of A¹ and A² is a monocyclic divalent aryl radical and Y¹ is a bridging radical having zero, one, or two atoms which separate A¹ from A². In an exemplary embodiment, one atom separates A¹ from A². Illustrative non-limiting examples of the Y¹ radicals are —O—, —S—, —S(O)—, —S(O)₂—, —C(O)—, methylene, cyclohexyl-methylene, 2-[2,2,1]-bicycloheptylidene, ethylidene, isopropylidene, neopentylidene, cyclohexylidene, cyclopentadecylidene, cyclododecylidene and adamantylidene. In another embodiment, zero atoms separate A¹ from A², with an illustrative example being biphenyl. The bridging radical Y¹ can be a saturated hydrocarbon group such as methylene, cyclohexylidene or isopropylidene.

The polycarbonate manufacturing process comprises the step of reacting an aromatic dihydroxy compound with a compound capable of introducing a carbonate bond. In the Schotten-Bauman reaction, commonly known as an ‘interfacial’ reaction, a dihydroxy compound is reacted with a carbonyl halide in a solvent system containing an organic solvent and water. Phosgene is often used as the carbonyl halide. Typically, an aqueous base such as sodium hydroxide, potassium hydroxide, calcium hydroxide, or the like, is mixed with the organic, water immiscible solvent such as benzene, toluene, carbon disulfide, or dichloromethane, which contains the dihydroxy compound. A phase transfer agent is generally used to facilitate the reaction. Molecular weight regulators may be added either singly or in admixture to the reactant mixture. Branching agents, described forthwith may also be added singly or in admixture.

Polycarbonates can be produced by the reaction of a dihydroxy compound with a carbonate precursor. As used herein, the term “dihydroxy compound” includes, for example, bisphenol compounds having general formula (3): 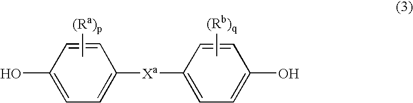
wherein R^{a} and R^{b} each independently represent hydrogen, a halogen atom, specifically bromine, or a monovalent hydrocarbon group, p and q are each independently integers from 0 to 4, and X^{a} represents one of the groups of formula (4): 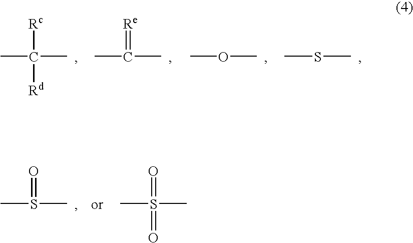
wherein R^{c} and R^{d} each independently or together represent a hydrogen atom or a monovalent linear or cyclic hydrocarbon group, and R^{e} is a divalent hydrocarbon group, oxygen, or sulfur.

Examples of the types of bisphenol compounds that may be represented by formula (3) include the bis(hydroxyaryl)alkane series such as, 1,1-bis(4-hydroxyphenyl)methane, 1,1-bis(4-hydroxyphenyl)ethane, 2,2-bis(4-hydroxyphenyl)propane (or bisphenol-A), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, bis(4-hydroxyphenyl)phenylmethane, 2,2-bis(4-hydroxy-1-methylphenyl)propane, 1,1-bis(4-hydroxy-t-butylphenyl)propane, 2,2-bis(4-hydroxy-3-bromophenyl)propane, or the like; bis(hydroxyaryl)cycloalkane series such as, 1,1-bis(4-hydroxyphenyl)cyclopentane, 1,1-bis(4-hydroxyphenyl)cyclohexane, or the like, 3,3-bis(4-hydroxyphenyl) phthalimidine, 2-phenyl-3,3-bis-(4-hydroxyphenyl) phthalimidine (PPPBP), or combinations comprising at least one of the foregoing bisphenol compounds.

Other bisphenol compounds that may be represented by formula (3) include those where X is —O—, —S—, —SO— or —S(O)₂—. Some examples of such bisphenol compounds are bis(hydroxyaryl)ethers such as 4,4′-dihydroxy diphenylether, 4,4′-dihydroxy-3,3′-dimethylphenyl ether, or the like; bis(hydroxy diaryl)sulfides, such as 4,4′-dihydroxy diphenyl sulfide, 4,4′-dihydroxy-3,3′-dimethyl diphenyl sulfide, or the like; bis(hydroxy diaryl) sulfoxides, such as, 4,4′-dihydroxy diphenyl sulfoxides, 4,4′-dihydroxy-3,3′-dimethyl diphenyl sulfoxides, or the like; bis(hydroxy diaryl)sulfones, such as 4,4′-dihydroxy diphenyl sulfone, 4,4′-dihydroxy-3,3′-dimethyl diphenyl sulfone, or the like; or combinations comprising at least one of the foregoing bisphenol compounds.

Other bisphenol compounds that may be used in the polycondensation of polycarbonate include those of formula (5): 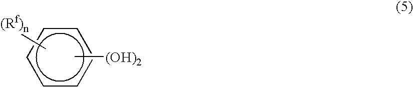
wherein, R^{f} is a halogen atom of a hydrocarbon group having 1 to 10 carbon atoms or a halogen substituted hydrocarbon group; n is a value from 0 to 4. When n is at least 2, R^{f,} may be the same or different. Examples of bisphenol compounds that may be represented by the formula (5), are resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, or the like; catechol, hydroquinone, substituted hydroquinones, such as 3-methyl hydroquinone, 3-ethyl hydroquinone, 3-propyl hydroquinone, 3-butyl hydroquinone, 3-t-butyl hydroquinone, 3-phenyl hydroquinone, 3-cumyl hydroquinone, or the like; or combinations comprising at least one of the foregoing bisphenol compounds.

Bisphenol compounds such as 2,2,2′,2′-tetrahydro-3,3,3′,3′-tetramethyl-1,1′-spirobi-[IH-indene]-6,6′-diol represented by formula (6) may also be used.

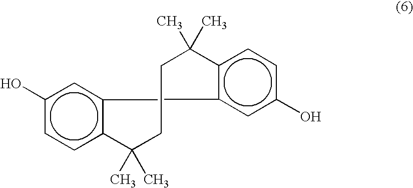

Suitable polycarbonates further include those derived from bisphenols containing alkyl cyclohexane units. Such polycarbonates have structural units corresponding to the formula (7): 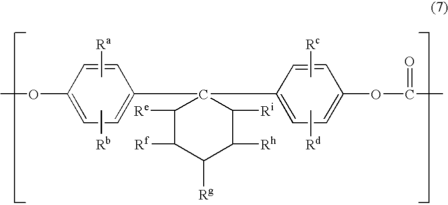
wherein R^{a}-R^{d} are each independently hydrogen, C₁₋₁₂ alkyl, or halogen; and Rₑ-Rᵢ are each independently hydrogen, C₁₋₁₂ alkyl. The residue may be aliphatic or aromatic, straight-chain, cyclic, bicyclic, branched, saturated, or unsaturated. The alkyl residue may contain heteroatoms over and above the carbon and hydrogen members of the substituent residue. Thus, when specifically noted as containing such heteroatoms, the alkyl residue may also contain carbonyl groups, amino groups, hydroxyl groups, or the like, or it may contain heteroatoms within the backbone of the alkyl residue. Alkyl cyclohexane containing bisphenols, for example the reaction product of two moles of a phenol with one mole of a hydrogenated isophorone, are useful for making polycarbonate polymers with high glass transition temperatures and high heat distortion temperatures. Such isophorone bisphenol-containing polycarbonates have structural units corresponding to the formula (8): 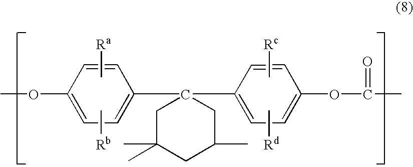
wherein Rₐ-R_{d} are as defined above. These isophorone bisphenol based polymers, including polycarbonate copolymers made containing non-alkyl cyclohexane bisphenols and blends of alkyl cyclohexyl bisphenol containing polycarbonates with non-alkyl cyclohexyl bisphenol polycarbonates, are supplied by Bayer Co. under the APEC™ trade name. A specifically useful bisphenol compound is bisphenol A (BPA).

In one embodiment, the dihydroxy compound may be reacted with a hydroxyaryl-terminated poly(diorganosiloxane) to create a polycarbonate-polysiloxane copolymer. Specifically the polycarbonate-poly(diorganosiloxane) copolymers are made by introducing phosgene under interfacial reaction conditions into a mixture of a dihydroxy compound, such as BPA, and a hydroxyaryl-terminated poly(diorganosiloxane). The polymerization of the reactants can be facilitated by use of a tertiary amine catalyst or a phase transfer catalyst.

The hydroxyaryl-terminated poly(diorganosiloxane) can be made by effecting a platinum catalyzed addition between a siloxane hydride of the formula (9): 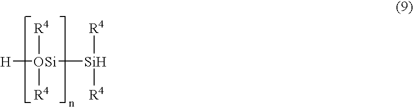
and an aliphatically unsaturated monohydric phenol wherein R₄ is, for example, C₁₋₈ alkyl radicals, haloalkyl radicals such as trifluoropropyl and cyanoalkyl radicals; aryl radicals such as phenyl, chlorophenyl and tolyl. In some embodiments, R₄ is specifically methyl, or a mixture of methyl and trifluoropropyl, or a mixture of methyl and phenyl.

Some of the aliphatically unsaturated monohydric phenols, which can be used to make the hydroxyaryl-terminated poly(diorganosiloxane)s are, for example, eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol, 2-allyl-4,6-dimethylphenol, or the like, or a combination comprising at least one of the foregoing.

Typical carbonate precursors include the carbonyl halides, for example carbonyl chloride (phosgene), and carbonyl bromide; the bis-haloformates, for example the bis-haloformates of dihydric phenols such as bisphenol A, hydroquinone, or the like, and the bis-haloformates of glycols such as ethylene glycol and neopentyl glycol; and the diaryl carbonates, such as diphenyl carbonate, di(tolyl) carbonate, and di(naphthyl) carbonate. A specific carbonate precursor for the interfacial reaction is carbonyl chloride.

It is also possible to employ polycarbonates resulting from the polymerization of two or more different dihydric phenols or a copolymer of a dihydric phenol with a glycol or with a hydroxy- or acid-terminated polyester or with a dibasic acid or with a hydroxy acid or with an aliphatic diacid in the event a carbonate copolymer rather than a homopolymer is desired for use. Generally, useful aliphatic diacids have about 2 to about 40 carbons. A specifically useful aliphatic diacid is dodecanedioic acid.

Branched polycarbonates, as well as blends of linear polycarbonate and a branched polycarbonate may also be used in the thermoplastic composition. The branched polycarbonates may be prepared by adding a branching agent during polymerization. These branching agents may comprise polyfunctional organic compounds containing at least three functional groups, which may be hydroxyl, carboxyl, carboxylic anhydride, haloformyl, and combinations comprising at least one of the foregoing branching agents. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) α,α-dimethyl benzyl)phenol), 4-chloroformyl phthalic anhydride, trimesic acid, benzophenone tetracarboxylic acid, or the like, or combinations comprising at least one of the foregoing branching agents. The branching agents may be added at a level of about 0.05 to about 4.0 weight percent (wt %), based upon the total weight of the polycarbonate in a given layer.

In one embodiment, the polycarbonate may be produced by a melt polycondensation reaction between a dihydroxy compound and a carbonic acid diester. Examples of the carbonic acid diesters that may be utilized to produce the polycarbonates are diphenyl carbonate, bis(2,4-dichlorophenyl)carbonate, bis(2,4,6-trichlorophenyl) carbonate, bis(2-cyanophenyl) carbonate, bis(o-nitrophenyl) carbonate, ditolyl carbonate, m-cresyl carbonate, dinaphthyl carbonate, bis(diphenyl) carbonate, diethyl carbonate, dimethyl carbonate, dibutyl carbonate, dicyclohexyl carbonate, bis(o-methoxycarbonylphenyl)carbonate, bis(o-ethoxycarbonylphenyl)carbonate, bis(o-propoxycarbonylphenyl)carbonate, bis-ortho methoxy phenyl carbonate, bis(o-butoxycarbonylphenyl)carbonate, bis(isobutoxycarbonylphenyl)carbonate, o-methoxycarbonylphenyl-o-ethoxycarbonylphenylcarbonate, bis o-(tert-butoxycarbonylphenyl)carbonate, o-ethylphenyl-o-methoxycarbonylphenyl carbonate, p-(tertbutylphenyl)-o-(tert-butoxycarbonylphenyl)carbonate, bis-methyl salicyl carbonate, bis-ethyl salicyl carbonate, bis-propyl salicyl carbonate, bis-butyl salicyl carbonate, bis-benzyl salicyl carbonate, bis-methyl 4-chlorosalicyl carbonate or the like, or combinations comprising at least one of the foregoing carbonic acid diesters. A specifically useful carbonic acid diester is diphenyl carbonate or bis-methyl salicyl carbonate.

The weight average molecular weight of the polycarbonate is about 3,000 to about 1,000,000 grams/mole (g/mole). In one embodiment, the polycarbonate has a weight average molecular weight of about 10,000 to about 100,000 g/mole. In another embodiment, the polycarbonate has a weight average molecular weight of about 20,000 to about 50,000 g/mole. In another embodiment, the polycarbonate has a weight average molecular weight of about 24,000 to about 35,000 g/mole. In another embodiment the polycarbonate has a weight average molecular weight of about 25,000 to 32,000 g/mole. All molecular weights are expressed as measured against BPA Polycarbonate standards.

Cycloaliphatic polyesters may be used in the thermoplastic composition, wherein such polyesters may have optical transparency, improved weatherability, chemical resistance, and low water absorption. It is generally desirable that, where used, cycloaliphatic polyesters have good melt compatibility with the polycarbonates used in the thermoplastic composition. In an exemplary embodiment, a cycloaliphatic polyester that displays good melt compatibility with the polycarbonate can be used in the thermoplastic composition. Cycloaliphatic polyesters are generally prepared by reaction of a diol with a dibasic acid or derivative. The diols useful in the preparation of the cycloaliphatic polyester polymers for use as the high quality optical sheets are straight chain, branched, or cycloaliphatic, and may contain from 2 to 12 carbon atoms.

Examples of suitable diols include ethylene glycol, propylene glycols such as 1,2- and 1,3-propylene glycol, butane diols such as 1,3- and 1,4-butane diol, diethylene glycol, 2,2-dimethyl-1,3-propane diol, 2-ethyl, 2-methyl, 1,3-propane diol, 1,3- and 1,5-pentane diol, dipropylene glycol, 2-methyl-1,5-pentane diol, 1,6-hexane diol, 1,4-cyclohexane dimethanol and particularly its cis- and trans-isomers, triethylene glycol, 1,10-decane diol, and combinations comprising at least one of the foregoing diols. Specifically useful is dimethanol bicyclo octane, dimethanol decalin, a cycloaliphatic diol or chemical equivalents thereof, and particularly 1,4-cyclohexane dimethanol or its chemical equivalents. If 1,4-cyclohexane dimethanol is to be used as the diol component, a mixture of cis- to trans-isomers in ratios of about 1:4 to about 4:1 can be used. Specifically, a ratio of cis- to trans-isomers of about 1:3 can be useful.

The diacids useful in the preparation of the cycloaliphatic polyester polymers are aliphatic diacids that include carboxylic acids having two carboxyl groups each of which are attached to a saturated carbon in a saturated ring. Suitable examples of cycloaliphatic acids include decahydro naphthalene dicarboxylic acid, norbornene dicarboxylic acids, and bicyclo octane dicarboxylic acids. Specifically useful cycloaliphatic diacids include 1,4-cyclohexanedicarboxylic acid and trans-1,4-cyclohexanedicarboxylic acids. Linear aliphatic diacids are also useful provided the polyester has at least one monomer containing a cycloaliphatic ring. Illustrative examples of linear aliphatic diacids are succinic acid, adipic acid, dimethyl succinic acid, and azelaic acid. Mixtures of diacid and diols may also be used to make the cycloaliphatic polyesters.

Cyclohexanedicarboxylic acids and their chemical equivalents can be prepared, for example, by the hydrogenation of cycloaromatic diacids and corresponding derivatives such as isophthalic acid, terephthalic acid or naphthalenic acid in a suitable solvent (e.g., water or acetic acid) at room temperature and at atmospheric pressure using catalysts such as rhodium supported on a carrier comprising carbon and alumina. They may also be prepared by the use of an inert liquid medium wherein an acid is at least partially soluble under reaction conditions and a catalyst of palladium or ruthenium in carbon or silica is used.

Generally, during hydrogenation, two or more isomers are obtained in which the carboxylic acid groups are in cis- or trans-positions. The cis- and trans-isomers can be separated by crystallization with or without a solvent, for example, n-heptane, or by distillation. The cis-isomer tends to be more miscible, however, the trans-isomer has higher melting and crystallization temperatures and is specifically suitable. Mixtures of the cis- and trans-isomers may also be used. The weight ratio of trans- to cis-isomer can be about 75:25. When a mixture of isomers or more than one diacid is used, a copolyester or a mixture of two polyesters may be used as the cycloaliphatic polyester polymer.

Chemical equivalents of these diacids including esters may also be used in the preparation of the cycloaliphatic polyesters. Suitable examples of the chemical equivalents of the diacids are alkyl esters, e.g., dialkyl esters, diaryl esters, anhydrides, acid chlorides, acid bromides, and the like, as well as combinations comprising at least one of the foregoing chemical equivalents. Useful chemical equivalents comprise the dialkyl esters of the cycloaliphatic diacids, while a specifically useful chemical equivalent comprises the dimethyl ester of the acid, particularly dimethyl-trans-1,4-cyclohexanedicarboxylate.

Dimethyl-1,4-cyclohexanedicarboxylate can be obtained by ring hydrogenation of dimethylterephthalate, and two isomers having the carboxylic acid groups in the cis- and trans-positions are obtained. Where the isomers can be separated, the trans-isomer is specifically useful. Mixtures of the isomers may also be used as detailed above.

The polyester polymers are generally obtained through the condensation or ester interchange polymerization of the diol or diol chemical equivalent component with the diacid or diacid chemical equivalent component and having recurring units of the formula (10): 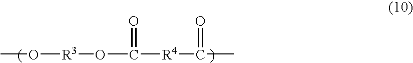
wherein R³ represents an alkyl or cycloalkyl radical containing 2 to 12 carbon atoms and which is the residue of a straight chain, branched, or cycloaliphatic alkane diol having 2 to 12 carbon atoms or chemical equivalents thereof; and R⁴ is an alkyl or a cycloaliphatic radical which is the decarboxylated residue derived from a diacid, with the proviso that at least one of R³ or R⁴ is a cycloalkyl group.

A useful cycloaliphatic polyester is poly(1,4-cyclohexane-dimethanol-1,4-cyclohexanedicarboxylate) (PCCD) having recurring units of formula (11): 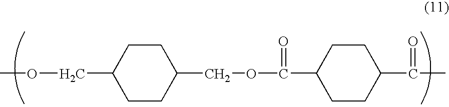
wherein in the formula (9) R³ is a cyclohexane ring, and wherein R⁴ is a cyclohexane ring derived from cyclohexanedicarboxylate or a chemical equivalent thereof and is selected from the cis- or trans-isomer or a mixture of cis- and trans-isomers thereof. Cycloaliphatic polyester polymers can be generally made in the presence of a suitable catalyst such as a tetra(2-ethyl hexyl)titanate, in a suitable amount, generally about 50 to 400 ppm of titanium based upon the total weight of the final product.

PCCD is generally completely miscible with the polycarbonate. It is generally desirable for a polycarbonate-PCCD mixture to have a melt volume rate of greater than or equal to about 5 cubic centimeters/10 minutes (cc/10 min or ml/10 min) to less than or equal to about 150 cubic centimeters/10 minutes when measured at 265° C., at a load of 2.16 kilograms and a four minute dwell time. Within this range, it is generally desirable to have a melt volume rate of greater than or equal to about 7, specifically greater than or equal to about 9, and more specifically greater than or equal to about 10 cc/10 min when measured at 265° C., at a load of 2.16 kilograms and a four minute dwell time. Also desirable within this range, is a melt volume rate of less than or equal to about 125, specifically less than or equal to about 110, and more specifically less than or equal to about 100 cc/10 minutes.

Other suitable cycloaliphatic polyesters that may be mixed with the polycarbonate are polyethylene terephthalate (PET), polybutylene terephthalate (PBT), poly(trimethylene terephthalate) (PTT), poly(cyclohexanedimethanol-co-ethylene terephthalate) (PETG), poly(ethylene naphthalate) (PEN), and poly(butylene naphthalate) (PBN).

Another polyester that may be mixed with other polymers are polyarylates. Polyarylates generally refers to polyesters of aromatic dicarboxylic acids and bisphenols. Polyarylate copolymers that include carbonate linkages in addition to the aryl ester linkages, are termed polyester-carbonates, and may also be advantageously utilized in the mixtures. The polyarylates can be prepared in solution or by the melt polymerization of aromatic dicarboxylic acids or their ester forming derivatives with bisphenols or their derivatives.

In general, the polyarylates comprise at least one diphenol residue in combination with at least one aromatic dicarboxylic acid residue. The diphenol residue, illustrated in formula (12), is derived from a 1,3-dihydroxybenzene moiety, referred to throughout this specification as resorcinol or resorcinol moiety. Resorcinol or resorcinol moieties include both unsubstituted 1,3-dihydroxybenzene and substituted 1,3-dihydroxybenzenes.

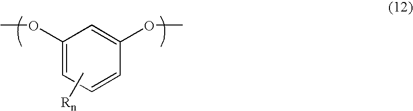

In formula (12), R is at least one of C₁₋₁₂ alkyl or halogen, and n is 0 to 3. Suitable dicarboxylic acid residues include aromatic dicarboxylic acid residues derived from monocyclic moieties, specifically isophthalic acid, terephthalic acid, or mixtures of isophthalic and terephthalic acids, or from polycyclic moieties such as diphenyl dicarboxylic acid, diphenylether dicarboxylic acid, and naphthalene-2,6-dicarboxylic acid, and the like, as well as combinations comprising at least one of the foregoing polycyclic moieties. A specifically suitable polycyclic moiety is naphthalene-2,6-dicarboxylic acid.

Specifically, the aromatic dicarboxylic acid residues can be derived from mixtures of isophthalic and/or terephthalic acids as generally illustrated in formula (13):

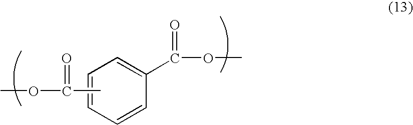

Therefore, in one embodiment the polyarylates comprise resorcinol arylate polyesters as illustrated in formula (14) wherein R and n are previously defined for formula (12): 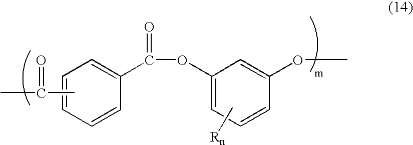
wherein R is at least one of C₁₋₁₂ alkyl or halogen, n is 0 to about 3, and m is at least about 8. Specifically, R can be hydrogen. Specifically, n is zero and m is about 10 and about 300. The molar ratio of isophthalate to terephthalate is about 0.25:1 to about 4.0:1.

In another embodiment, the polyarylate comprises thermally stable resorcinol arylate polyesters that have polycyclic aromatic radicals as shown in formula (15): 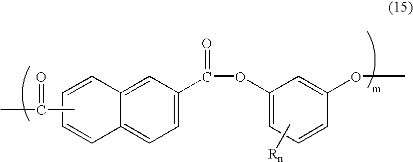
wherein R is at least one of C₁₋₁₂ alkyl or halogen, n is 0 to about 3, and m is at least about 8.

In another embodiment, the polyarylates are copolymerized to form block copolyestercarbonates, which comprise carbonate and arylate blocks. They include polymers comprising structural units of the formula (16): 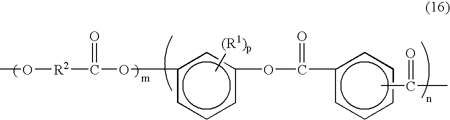
wherein each R¹ is independently halogen or C₁₋₁₂ alkyl, m is at least 1, p is about 0 to about 3, each R² is independently a divalent organic radical, and n is at least about 4. Specifically n is at least about 10, more specifically at least about 20 and most specifically about 30 to about 150. Specifically m is at least about 3, more specifically at least about 10 and most specifically about 20 to about 200. In an exemplary embodiment m is present in an amount of about 20 and 50.

It is generally desirable for the weight average molecular weight of the polyester to be about 500 to about 1,000,000 grams/mole (g/mole). In one embodiment, the polyester has a weight average molecular weight of about 10,000 to about 200,000 g/mole. In another embodiment, the polyester has a weight average molecular weight of about 30,000 to about 150,000 g/mole. In yet another embodiment, the polyester has a weight average molecular weight of about 50,000 to about 120,000 g/mole. An exemplary molecular weight for the polyester can be 60,000 and 120,000 g/mole. These molecular weights are determined against a polystyrene standard.

The polycarbonate is generally used in amounts of about 70 to about 99.9 weight percent (wt %) based upon the weight of the thermoplastic composition. In one embodiment, the polycarbonate is present in an amount of about 75 to about 99.7 wt %, based on the total weight of the thermoplastic composition. In another embodiment, the polycarbonate is present in an amount of about 80 to about 99.5 wt %, based on the total weight of the thermoplastic composition. In yet another embodiment, the polycarbonate is present in an amount of about 85 to about 97 wt %, based on the total weight of the thermoplastic composition.

The polycarbonate composition further comprises a lithium-containing flame retardant salt. Non-limiting examples of flame retardant salts are sulfonates and sulfone sulfonates. In one embodiment the flame retardant salt is a lithium perfluoroalkyl sulfonate. Non-limiting examples are the lithium salts of perfluoroethane sulfonate, perfluoropropane sulfonate, perfluorobutane sulfonate, perfluoropentane sulfonate, perfluorohexane sulfonate and perfluorooctane sulfonate. Lithium perfluorobutane sulfonate is preferred.

In another embodiment the flame retardant salt is a structure according to formula (17) 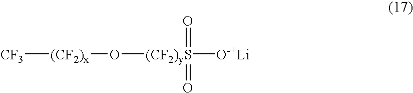
wherein x is an integer from 0 to 8 and y is an integer from 1 to 8.

The flame retardant additive can be used in an amount of about 0.06 to about 0.3 % by weight, specifically about 0.09 to about 0.2% by weight, and more specifically about 0.10 to about 0.15% by weight based on the total weight of the composition.

Thus, the composition can have a melt flow rate (MVR) of about 1 to about 17 cubic centimeters per 10 minutes flow (cc/10 min.), specifically about 1.5 to about 15 cc/10 min., and more specifically about 2 to about 12 cc/10 min., as determined at 300° C. with a 4 minute dwell time and 1.2 Kg according to ISO 1133.

The flame retardancy of the composition may be determined by measuring the oxygen index (O.I.) of the material. The oxygen index of a material is defined as (IS04589-2): the minimum concentration of oxygen, expressed as volume percent, in a mixture of oxygen and nitrogen that will just support flaming combustion of a material initially at room temperature under the conditions of this method. A composition with an Oxygen Index close to 21% is very combustible. A material with an Oxygen Index that is significantly higher, for example over 30% exhibits self extinguishing characteristics. The Oxygen Index of pure bisphenol-A polycarbonate without flame retardant additives is about 29%.

In one embodiment the polycarbonate compositions have an O.I. greater than 34%. In a preferred embodiment the polycarbonate compositions have an O.I. greater than 35%. In a particularly preferred embodiment the Oxygen Index is greater than 35.5%. It has been empirically observed that an Oxygen Index greater than 35.5% seems to correlate with a UL94 performance of V0 in compositions according to the invention provided the compositions contain a polycarbonate of sufficient molecular weight. Since UL94 performance has been shown to depend also on molecular weight of the polycarbonate it is hence less of a measure of the intrinsic flame retardancy of the composition. Certain additives may decrease the Oxygen Index of the composition, for example compounds with linear or branched alkyl groups such as common release agents. This may require the addition of slightly higher amounts of flame retardant salt than when these compounds are not present.

In one embodiment the composition further comprises an acidic compound to stabilize the composition against degradation due to impurities in the lithium containing flame retardant additive. A typical impurity in the flame retardant additive is lithium hydroxide, which may degrade the polycarbonate, particularly during processing at elevated temperatures and with higher loadings of the flame retardant additive. Non limiting examples of acidic compounds that can be used as stabilizers are inorganic acids like phosphorous acid, phosphoric acid, sulphorous acid and sulphonic acids. Also organic acid esters such as butyl para-toluene sulfonic acid (butyl tosylate) can be used. In one embodiment the stabilizers are employed at levels between 0.1 and 20 ppm, preferably at 3 to 10 ppm. It will be evident to the person skilled in the art that the exact amount of acid stabilizer to be added is dependent on the nature and amount of impurities in the flame retardent additive and the loading of the flame retardant additive itself. The addition of an excess of acid can conversely lead to degradation of the polycarbonate in the composition.

The composition can further comprise a UV absorbing additive. Suitable UV absorbing additives are benzophenones such as 2,4dihydroxybenzophenone, 2-hydroxy-4-methoxybenzophenone, 2-hydroxy-4-n-octoxybenzophenone, 4-dodecyloxy-2hydroxybenzophenone, 2-hydroxy-4-octadecyloxybenzophenone, 2,2′dihydroxy-4methoxybenzophenone, 2,2′dihydroxy-4,4′dimethoxybenzophenone, 2,2′dihydroxy-4methoxybenzophenone, 2,2′,4,4′tetra hydroxybenzophenone, 2-hydroxy-4-methoxy-5 sulfobenzophenone, 2-hydroxy-4-methoxy-2′-carboxybenzophenone, 2,2′dihydroxy-4,4′dimethoxy-5sulfobenzophenone, 2-hydroxy-4-(2-hydroxy-3-methylaryloxy) propoxybenzophenone, 2-hydroxy-4chlorobenzopheone, or the like; benzotriazoles such as 2-(2-hydroxy-5-tert-octylphenyl)-benzotriazole, 2-hydroxy-4-n-octoxy benzophenone 2-(2-hydroxy-5-methyl phenyl) benzotriazole, 2-(2-hydroxy-3′,5′-di-tert-butyl phenyl) benzotriazole, and 2-(2-hydroxy-X-tert, butyl-5′-methyl-phenyl) benzotriazole, or the like; salicylates such as phenyl salicylate, carboxyphenyl salicylate, p-octylphenyl salicylate, strontium salicylate, p-tert butylphenyl salicylate, methyl salicylate, dodecyl salicylate, or the like; and also other ultraviolet absorbents such as resorcinol monobenzoate, 2 ethyl hexyl-2-cyano, 3-phenylcinnamate, 2-ethyl-hexyl-2-cyano-3,3-diphenyl acrylate, ethyl-2-cyano-3,3-diphenyl acrylate, 2-2′-thiobis(4-t-octylphenolate)-1-n-butylamine, or the like, or combinations comprising at least one of the foregoing UV absorbing additives. Preferred commercially available UV absorbers are TINUVIN™ 234, TINUVIN™ 329, TINUVIN™ 350 and TINUVIN™ 360, commercially available from Ciba Specialty Chemicals; CYASORB™ UV absorbers, available from Cyanamide, such as 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis [[(2-cyano-3,3-diphenylacryloyl)oxy]methyl]propane (UVINUL™ 3030); 2,2′-(1,4-phenylene) bis(4H-3,1-benzoxazin-4-one); 1,3-bis [(2-cyano-3,3-diphenylacryloyl)oxy]-2,2-bis [[(2-cyano-3,3-diphenylacryloyl)oxy]methyl]propane. For articles formed by extrusion, UVINUL™ 3030, commercially available from BASF, is specifically useful due to its low volatility.

The UV absorbers can be used in the composition in amounts of about 0.05 to about 5 wt %, based upon the total weight of the composition. In one embodiment, the UV absorber may be used in an amount of about 0.1 to about 0.5 wt %, specifically about 0.2 to about 0.4 wt %, based on the total weight of the composition.

The composition can contain thermal stabilizers to protect the material during processing operations such as melt blending. The addition of thermal stabilizers to the composition improves the long term aging characteristics and increases the life cycle of the article.

In another embodiment thermal stabilizers may be optionally added to the composition to prevent degradation of the organic polymer during processing and to improve heat stability of the article. Suitable thermal stabilizers include phosphites, phosphonites, phosphines, hindered amines, hydroxyl amines, phenols, acryloyl modified phenols, hydroperoxide decomposers, benzofuranone derivatives, or the like, or combinations comprising at least one of the foregoing thermal stabilizers. Examples include, but are not limited to, phosphites such as tris(nonyl phenyl) phosphite, tris(2,4-di-t-butylphenyl) phosphite, bis(2,4-di-t-butylphenyl) pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis [3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Suitable thermal stabilizers that are commercially available are IRGAPHOS™ 168, DOVERPHOS™ S-9228, ULTRANOX™ 641, Phosphite PEPQ or the like. If desirable, an optional co-stabilizer such as a aliphatic epoxy or a hindered phenol anti-oxidant such as IRGANOX™ 1076, IRGANOX™ 1010, both from Ciba Specialty chemicals may also be added to improve thermal stability of the composition. The preferred thermal stabilizers are phosphites.

The thermal stabilizer can be present in an amount of about 0.001 to about 3 wt %, specifically about 0.002 to about 1 wt %, more specifically about 0.005 to about 0.5 wt %, and still more specifically about 0.01 to about 0.1 wt %, based on the total weight of the composition. The exact amount of thermal stabilizer needed may depend on the presence of other additives, the molecular weight of the polycarbonate and the size and shape of the article to be prepared and may be readily determined by the person skilled in the art.

Plasticizers, lubricants, and/or mold release agents additives may also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; polyalpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials can be used in amounts of about 0.0001 to about 1.0 wt %, based on the total weight of the composition.

The term “antistatic agent” refers to monomeric, oligomeric, or polymeric materials that can be processed into polymer resins and/or sprayed onto materials or articles to improve conductive properties and overall physical performance. Examples of monomeric antistatic agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example Pelestat™ 6321 (Sanyo) or Pebax™ MH1657 (Atofina), Irgastat™ P18 and P22 (Ciba-Geigy). Other polymeric materials that may be used as antistatic agents are inherently conducting polymers such as polyaniline (commercially available as PANIPOL®EB from Panipol), polypyrrole and polythiophene (commercially available from Bayer), which retain some of their intrinsic conductivity after melt processing at elevated temperatures. In one embodiment, carbon fibers, carbon nanofibers, carbon nanotubes, carbon black, or any combination of the foregoing may be used in a polymeric resin containing chemical antistatic agents to render the composition electrostatically dissipative.

Antistatic agents that are particularly suitable for use herein include onium salts of alkyl sulfonates, particularly alkylated and arylated onium salts of perfluorinated alkyl sulfonates. Exemplary onium salts are phosphonium, ammonium, sulfonium, imidazolinium, pyridinium or tropilium salt. Preferable are alkylated ammonium and phosphonium salts of perfluorinated alkyl sulfonates. Most preferable alkylated phosphonium sulfonates. Specifically useful phosphonium sulfonates include fluorinated phosphonium sulfonates, which can comprise a fluorocarbon containing an organic sulfonate anion, and an organic phosphonium cation. Suitable examples of such organic sulfonate anions include, but are not limited to, perfluoro methane sulfonate, perfluoro butane sulfonate, perfluoro hexane sulfonate, perfluoro heptane sulfonate, perfluoro octane sulfonate, combinations comprising one or more of these, and the like. Suitable examples of the aforementioned phosphonium cation include, but are not limited to, aliphatic phosphonium such as tetramethyl phosphonium, tetraethyl phosphonium, tetrabutyl phosphonium, triethylmethyl phosphonium, tributylmethyl phosphonium, tributylethyl phosphonium, trioctylmethyl phosphonium, trimethylbutyl phosphonium trimethyloctyl phosphonium, trimethyllauryl phosphonium, trimethylstearyl phosphonium, triethyloctyl phosphonium and aromatic phosphoniums such as tetraphenyl phosphonium, triphenylmethyl phosphonium, triphenylbenzyl phosphonium, tributylbenzyl phosphonium, combinations comprising one or more of the foregoing, and the like. Suitable examples of the aforementioned ammonium cation include, but are not limited to, aliphatic ammonium such as tetramethyl ammonium, tetraethyl ammonium, tetrabutyl ammonium, triethylmethyl ammonium, tributylmethyl ammonium, tributylethyl ammonium, trioctylmethyl ammonium, trimethylbutyl ammonium trimethyloctyl ammonium, trimethyllauryl ammonium, trimethylstearyl ammonium, triethyloctyl ammonium and aromatic ammoniums such as tetraphenyl ammonium, triphenylmethyl ammonium, triphenylbenzyl ammonium, tributylbenzyl ammonium, combinations comprising one or more of the foregoing, and the like. A combination comprising at least one of the foregoing antistatic agents may also be used. The anions of the above mentioned antistatic agents are the same or similar to some of the flame retardant additives described herein. The difference between the antistatic compounds and the flame retardant additives lies in the cation. When a Lithium ion is present the compound acts as a flame retardant, while an onium cation, such as tetrabutylphosphonium gives the compound the anti-static property. A well-known anti-static agent, tetrabutyl phosphonium perfluorobutane sulfonate, has been shown to actually deteriorate the flame retardant properties of a polycarbonate composition. Hence the use of an antistatic agent may require a slight reformulation of the composition comprising the flame retardant salt by increasing the amount of flame retardant salt as may readily determined by the person skilled in the art.

Antistatic agents can be used in amounts of about 0.0001 to about 5.0 wt %, based on the total weight of the composition.

Colorants such as pigment and/or dye additives may also be present. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments. Pigments can be used in amounts of about 0.01 to about 10 wt %, based on the total weight of the composition.

Suitable dyes can be organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl-or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene; chrysene; rubrene; coronene, or the like, or combinations comprising at least one of the foregoing dyes. Dyes can be used in amounts of about 0.01 to about 10 wt %, based on the total weight of the composition.

Other inorganic flame retardants may also be used, for example salts of C₂₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate, and the like; salts formed by reacting for example an alkali metal or alkaline earth metal (for example sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complex such as Li₃AlF₆, BaSiF₆, KBF₄, K₃AIF₆, KAlF₄, K₂SiF₆, and/or Na₃AIF₆ or the like. When present, inorganic flame retardant salts can be present in amounts of about 0.1 to about 5 wt %, based on the total weight of the composition, provided the inorganic flame retardant salts do not adversely affect the transparency of the composition.

Radiation stabilizers may also be present in the composition, specifically gamma-radiation stabilizers. Suitable gamma-radiation stabilizers include diols, such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; alicyclic alcohols such as 1,2-cyclopentanediol, 1,2-cyclohexanediol, and the like; branched acyclic diols such as 2,3-dimethyl-2,3-butanediol (pinacol), and the like, and polyols, as well as alkoxy-substituted cyclic or acyclic alkanes. Alkenols, with sites of unsaturation, are also a useful class of alcohols, examples of which include 4-methyl-4-penten-2-ol, 3-methyl-pentene-3-ol, 2-methyl-4-penten-2-ol, 2,4-dimethyl-4-pene-2-ol, and 9-decen-1-ol. Another class of suitable alcohols is the tertiary alcohols, which have at least one hydroxy substituted tertiary carbon. Examples of these include 2-methyl-2,4-pentanediol (hexylene glycol), 2-phenyl-2-butanol, 3-hydroxy-3-methyl-2-butanone, 2-phenyl-2-butanol, and the like, and cycoloaliphatic tertiary carbons such as 1-hydroxy-1-methyl-cyclohexane. Another class of suitable alcohols is hydroxymethyl aromatics, which have hydroxy substitution on a saturated carbon attached to an unsaturated carbon in an aromatic ring. The hydroxy substituted saturated carbon may be a methylol group (—CH₂OH) or it may be a member of a more complex hydrocarbon group such as would be the case with (—CR⁴HOH) or (—CR₂⁴OH) wherein R⁴ is a complex or a simply hydrocarbon. Specific hydroxy methyl aromatics may be benzhydrol, 1,3-benzenedimethanol, benzyl alcohol, 4-benzyloxy benzyl alcohol and benzyl benzyl alcohol. Specific alcohols are 2-methyl-2,4-pentanediol (also known as hexylene glycol), polyethylene glycol, polypropylene glycol. Gamma-radiation stabilizing compounds can be used in amounts of 0.001 to 1 wt %, more specifically 0.01 to 0.5 wt %, based on the total weight of the composition.

The compositions may be manufactured by methods generally available in the art, for example, in one embodiment, in one manner of proceeding, powdered or granulated polycarbonate resin, inorganic infrared shielding additive, carbon black, UV additive, thermal stabilizer, and any optional components are first blended in a HENSCHEL-Mixer® high speed mixer. Other low shear processes including but not limited to hand mixing may also accomplish this blending. The blend is then fed into the feedthroat of a twin-screw extruder via a hopper. Alternatively, one or more of the components may be incorporated into the composition by feeding directly into the extruder at the feedthroat and/or a downstream feedport. Such additives may also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate may be one-fourth inch long or less as desired. Such pellets may be used for subsequent molding, shaping, or forming.

A masterbatch can be prepared for use with a base resin to prepare the composition. As used herein, the term “masterbatch” refers to a dispersion of flame retardant additive and optionally other additives in a carrier resin, and typically is in the form of a pellet or bead formed using a mixing process such as a compounding/extrusion process. Also as used herein, the term “masterblend” generally refers to a dispersion of the marked additives in a powder carrier. Preparing the masterbatch comprises melt combining a masterblend comprising a carrier resin, a flame retardant additive salt package comprising the flame retardant additive and optionally any desired additional components such as, for example, the UV additive and/or thermal stabilizer. In one embodiment, the carrier resin is a polycarbonate resin. The masterbatch can be melt combined with a base resin and other additives to form the composition. In one embodiment, the base resin is a polycarbonate resin. In another embodiment, the base resin is the same as the carrier resin used to prepare the masterbatch. The masterbatch can be combined with the base resin as described above using a mixer, and extruded. In one embodiment, the masterbatch and base resin are combined at the feedthroat of an extruder. In another embodiment, the base resin is added to the feedthroat of the extruder, and the masterbatch is added to a downstream feedport of the extruder.

The masterbatch is added to the base resin in an amount of about 1 to about 80 wt %, specifically about 2 to about 60 wt %, more specifically about 3 to about 40 wt %, still more specifically about 5 to about 30 wt %, and still more specifically about 10 to about 20 wt % based on the combined weight of the masterbatch and the base resin. The exact amounts of additives in the masterbatch; the amount of masterbatch relative to the base resin and the location where the masterbatch is added to the extruder may depend on the nature of the other additives to be added and the particular hardware available.

The composition may be processed into articles such as films, sheets, multiwall sheets, plaques, and the like. The composition is generally compounded and either melt or solution blended in devices that can impart shear to the composition to disperse the lithium containing flame retardant salt. It is desirable to melt blend the composition. Suitable examples of such blending devices are extruders (e.g., single and twin screw extruders), Buss-kneaders, helicones, Waring® blenders, HENSCHEL-Mixers®, Banbury® mixers, a molding machine such as an injection molding machine, a blow molding machine, a vacuum forming machine, and the like. When the composition is melt blended in an extruder, Buss-kneader, Banbury® mixer, helicone, Waring® Blender, HENSCHEL-Mixers®, or the like, it may be optionally desirable to further subject the melt blend to additional shearing in a roll mill. A preferred method of blending is in an injection molding machine.

In one embodiment, in the extrusion of an article from the composition, the additives (e.g., flame retardant additive, colorant, thermal stabilizer and the UV absorbing additive) may be added to the extruder along with the polycarbonate resin at the feedthroat. In another embodiment, in the extrusion of the article, the additives may be added to the extruder in the form of a masterbatch. While the polycarbonate resin is fed to the feedthroat of the extruder, the masterbatch may be fed either at the feedthroat of the extruder or at a downstream feedport. In one exemplary embodiment, in the production of the article, the polycarbonate resin is fed to the feedthroat of a single or twin screw extruder while the flame retardant additive, colorant, thermal stabilizer and the UV absorbing additive are added in masterbatch form to a downstream feedport.

The articles manufactured from the compositions can be layers such as for example films, sheets, plaques, or other molded articles. A film is a layer having a thickness of about 0.1 to about 1000 micrometers, while in general a sheet, plaque, or other molded article has a thickness of greater than about 1000 micrometers to about 20 millimeters (mm).

In a specific embodiment, the article can have a thickness of about 0.05 to about 20 millimeters (mm), specifically about 0.1 to about 15 mm, more specifically about 0.5 to about 12 mm, and still more specifically about 1 to about 10 mm.

Molded test articles can be prepared by injection molding. Molded test articles may be, for example, flat, smooth plaques that are 60×60×5.0 millimeters. The person preparing an article from a composition according to the invention may have to some limited experimentation to find the optimum molding conditions. The skilled person should vary the time, temperature, mold composition and smoothness in order to determine which conditions will yield a molded test article with the lowest possible haze using the composition of the invention. In general the viscosity of the polycarbonate, the size of the article, and the desired cycle time determine the molding conditions. General conditions for molding different polycarbonates depending on viscosity/molecular weights are:

| Viscosity | | | | Low to | High to very |
|---|---|---|---|---|---|
| Mw (kg/mol, PC | | Very low | Low | medium | high |
| Standards) | | 18-20 | 20-24 | 24-29 | 29-37 |
| T predrying | (° C.) | 120 | 120 | 120 | 120 |
| T predrying | hrs | 2 | 2 | 2 | 2 |
| T hopper | (° C.) | 40 | 40 | 40 | 40 |
| T zone 1 | (° C.) | 260 | 270 | 280 | 290 |
| T zone 2 | (° C.) | 270 | 280 | 290 | 300 |
| T zone 3 | (° C.) | 280 | 290 | 300 | 310 |
| T die | (° C.) | 275 | 285 | 295 | 305 |
| T mold | (° C.) | 90 | 90 | 90 | 100 |

Small deviations from the above conditions may need to be made to obtain an article with excellent optical and mechanical properties as may be readily determined by the person skilled in the art.

In one embodiment, articles manufactured from the composition may comprise single-layered or multilayered films or sheets. Single-layered films or sheets may generally be produced by extrusion (i.e., film or sheet extrusion). Multilayered films or sheets may generally be produced by extrusion followed by laminating the films or sheets in a roll mill or a roll stack. The extrusion of the individual layers of the single or multilayered film or sheet may be performed in a single screw extruder or in a twin screw extruder. It is desirable to extrude the layers in a single or twin screw extruder and to laminate the layers in a roll mill. It is more desirable to co-extrude the layers in a single screw extruder or twin screw extruder and to optionally laminate the layers in a roll mill. The roll mill may be either a two roll or three roll mill, as is desired. Where desired, the layers can be co-extruded using single screw extruders for manufacturing of the multilayered film or sheet. In a multiwall article, the respective sheets that constitute the multiwall may have similar or different compositions as desired. In one embodiment, related to the manufacturing of multiwall articles such as films or sheets, the desired compositions for the article may be separately precompounded prior to co-extrusion. In this event, the precompounded composition(s) may be first melt blended in a twin screw extruder, single screw extruder, Buss kneader, roll mill, or the like, prior to being formed into a suitable shapes such as pellets, sheets, and the like, for further co-extrusion. The precompounded compositions may then be fed into the respective extruders for co-extrusion. As stated above, where a multilayered structure is desired, the layers of the multilayered articles are co-extruded (i.e., prepared by multilayer co-extrusion). In one embodiment, in one manner of co-extruding of the multilayered sheet, the melt streams (extrudates) from the various extruders are fed into a feed block die where the various melt streams are combined before entering the die. In another embodiment, the melt streams from the various extruders are fed into a multi-manifold internal combining die. The different melt streams enter the die separately and join just inside the final die orifice. In yet another embodiment, the melt streams from the various extruders are fed into a multi-manifold external combining die. The external combining dies have completely separate manifolds for the different melt streams as well as distinct orifices through which the streams leave the die separately, joining just beyond the die exit. The layers are combined while still molten and just downstream of the die. An exemplary die used in the production of the multilayered sheet is a feed block die. In an exemplary embodiment, the extruders used for the co-extrusion of the respective layers of the multilayer sheet are single screw extruders respectively. The co-extruded sheet may optionally be calendared in a roll mill if desired. The multilayered sheet can have a thickness of about 0.5 to about 35 milimeters.

In yet another embodiment, the composition may be subjected to molding either prior to or after extrusion to manufacture a flame retardant transparent article. The molding can be by injection molding, compression molding, extrusion molding, blow molding, or a combination comprising one of these. Molding may be followed by further processing such as shaping, thermoforming, cold-forming, cutting, coating, or a combination comprising one or more of these processes.

### EXAMPLES

For the purpose of clarification the following non-limiting examples are given to further illustrate the invention.

Lithium perfluorobutane sulfonate is prepared by dissolving 110.5 grams of potassium perfluorobutane sulfonate (KPFBS) in 500 ml of a 2:3 (w/w) mixture of ethanol/water. The solution is heated to about 50° C. to completely dissolve the KPFBS. The solution is then filtered and passed through an ion-exchange column containing Amberjet 1200H to convert the KPFBS into its sulfonic acid equivalent. The ion-exchange column is flushed with 3 volumes of demineralized water to elute all sulfonic acid product. The resulting solution is titrated with a 5% by weight LiOH solution to a pH of about 3 to form the Lithium perfluorobutane sulfonate. The solvent is evaporated and the product is dried to recover the final product.

Polycarbonate compositions were prepared by preparing hand mixed powder mixes of the ingredients and compounding them on a Werner and Pfleiderer™ 25 mm intermeshing twin screw extruder at 300 rpm with barrel temperatures 40-200-250-270-285-285-285-285-285-285° C. at a throughput of about 20 kg/hr. The color plaques used for this study were molded on an Engel 45T molding apparatus having 4 temperature zones set at 280-290-300-295° C. (mold temperature 90° C.).

Polymer molecular weight was determined by gel permeation chromatography (GPC) using a crosslinked styrene-divinylbenzene gel column, a sample concentration of about 1 milligram per milliliter in methylene chloride, and was calibrated using polycarbonate standards. Melt-volume rate (MVR) measurements were done at 300° C. with a dwell time of 4 minutes and 1.2 Kg load according to ISO 1133. Pre-drying of the polycarbonate granulate was done at 120° C. for 2 hours. Haze and transmission (% T) were measured on 5 millimeter color plaques according to ASTM D1003-00 using a BYK Gardner haze-guard dual with a D65 light source. Oxygen Index was measured on standard ISO impact bars (dimensions 80×10×40 mm) according to ISO4589-2. The components used to prepare the materials used in the examples and comparative examples are listed in Table 1, below.

TABLE 1

| Component | Material type | Trade Name | Source |
|---|---|---|---|
| PC | Bisphenol-A Polycarbonate | LEXAN ™ | GE |
| | resin (powder), | | Plastics |
| | Mw = 30,500 | | |
| PETS | Pentaerythritol pentastearate | COGNIS | |
| I-168 | (tris(2,4-di-(tert)-butylphenyl) | IRGAFOS ™ | Great |
| | phosphite) (stabilizer) | 168 | Lakes |
| | | | Chemical |
| K-FPBS | Potassium perfluorobutane | RIMAR | 3M |
| | sulfonate | | |
| Li-FPBS | Lithium perfluorobutane | none | GE |
| | sulfonate | | Plastics |
| H₃PO₃ | Phosphorous acid, added as | none | Quaron |
| | masterbatch in water 1:1000 | | |

TABLE 2

| | | Amounts | | | | | |
|---|---|---|---|---|---|---|---|
| Chemical Name | | in wt % | C. E. 1 | C. E. 2 | C. E. 3 | C. E. 4 | C. E. 5 |
| PC | | | 99.56 | 99.54 | 99.52 | 99.5 | 99.45 |
| PETS | | | 0.35 | 0.35 | 0.35 | 0.35 | 0.35 |
| I-168 | | | 0.05 | 0.05 | 0.05 | 0.05 | 0.05 |
| K-PFBS | | | 0.04 | 0.06 | 0.08 | 0.1 | 0.15 |
| Li-PFBS | | | | | | | |
| RESULTS | | | | | | | |
| Optical Properties | Transmission | (%) | | 89.7 | 85.6 | 80.4 | 58.2 |
| ASTM D1003 | St. Dev. | — | | 0.05 | 0.10 | 0.32 | 0.92 |
| @ 5 mm | Haze | — | | 0.5 | 3.8 | 9.9 | 70.8 |
| | St. Dev. | — | | 0.10 | 0.09 | 0.16 | 1.48 |
| MVR (300° C./1.2 kg) | 4 minutes | cm³/10 min. | 11.5 | 11.7 | 11.9 | 11.8 | 11.8 |
| ISO 1133 | | | | | | | |
| Molecular weight | Mw | (g/mol) | 25500 | 25700 | 25800 | 25700 | 25600 |
| | Mn | (g/mol) | 9480 | 9590 | 9550 | 9530 | 9510 |
| | PD | — | 2.69 | 2.68 | 2.70 | 2.69 | 2.69 |
| Flame retardancy | Oxygen Index | (%) | 35.95 | 34.75 | 35.75 | 37.65 | 33.95 |
| ISO4589-2 | | stdev | 0.23 | 0.23 | 0.23 | 0.29 | 0.23 |
| | | Amounts | | | | | |
| Chemical Name | | in wt % | Ex 6 | Ex 7 | Ex 8 | Ex 9 | Ex 10 |
| PC | | | 99.56 | 99.54 | 99.52 | 99.5 | 99.45 |
| PETS | | | 0.35 | 0.35 | 0.35 | 0.35 | 0.35 |
| I-168 | | | 0.05 | 0.05 | 0.05 | 0.05 | 0.05 |
| K-PFBS | | | | | | | |
| Li-PFBS | | | 0.04 | 0.06 | 0.08 | 0.1 | 0.15 |
| RESULTS | | | | | | | |
| Optical Properties | Transmission | (%) | | 90.1 | 90.2 | 90.2 | 90.1 |
| ASTM D1003 | St. Dev. | — | | 0.06 | 0.10 | 0.06 | 0.10 |
| @ 5 mm | Haze | — | | 0.4 | 0.4 | 0.4 | 0.4 |
| | St. Dev. | — | | 0.03 | 0.04 | 0.04 | |
| MVR (300° C./1.2 kg) | 4 minutes | cm³/10 min. | 12.5 | 13.6 | 13.3 | 15.0 | 16.4 |
| ISO 1133 | | | | | | | |
| Molecular weight | Mw | (g/mol) | 25200 | 24800 | 24900 | 24400 | 23500 |
| | Mn | (g/mol) | 9440 | 9290 | 9350 | 9240 | 8970 |
| | PD | — | 2.67 | 2.67 | 2.66 | 2.64 | 2.62 |
| Flame retardancy | Oxygen Index | (%) | 33.05 | 34.43 | 34.65 | 35.55 | 36.43 |
| ISO4589-2 | | stdev | 0.29 | 0.28 | 0.29 | 0.27 | 0.28 |

TABLE 3

| Chemical Name | | | Ex 11 | Ex 12 | Ex 13 | Ex 14 |
|---|---|---|---|---|---|---|
| PC | | wt % | 99.5 | 99.5 | 99.5 | 99.45 |
| PETS | | wt % | 0.35 | 0.35 | 0.35 | 0.35 |
| I-168 | | wt % | 0.05 | 0.05 | 0.05 | 0.05 |
| H₃PO₃ | | ppm | 4.5 | 6.75 | 9 | 6.75 |
| K-PFBS | | wt % | | | | |
| Li-PFBS | | wt % | 0.1 | 0.1 | 0.1 | 0.15 |
| RESULTS | | | | | | |
| MVR (300° C./1.2 kg) | 4 minutes | cm³/10 min. | 12.7 | 12.8 | 13.0 | 12.8 |
| ISO 1133 | | | | | | |
| Molecular weight | Mw | (g/mol) | 25200 | 25000 | 24900 | 24800 |
| (GPC) | Mn | (g/mol) | 9420 | 9330 | 9300 | 9230 |
| | PD | — | 2.67 | 2.68 | 2.68 | 2.68 |
| Flame retardancy | Oxygen Index | (%) | 35.05 | 35.65 | 36.35 | 35.35 |
| ISO 4589 | | stdev | 0.29 | 0.29 | 0.23 | 0.27 |

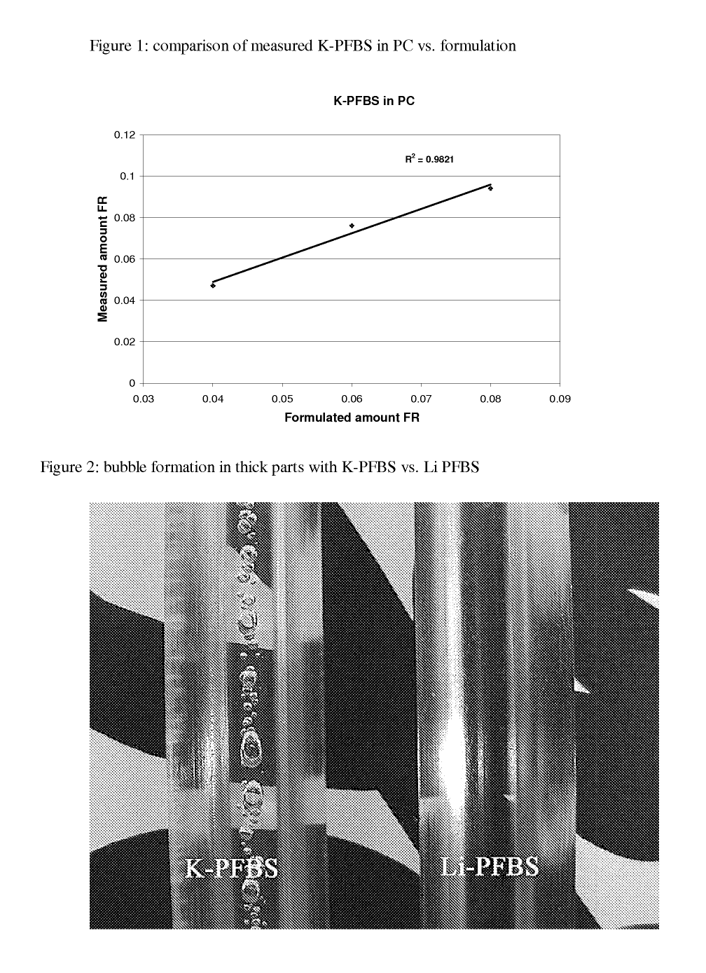

Comparative examples 1 to 5 show a significant non-linear behaviour of the Oxygen Index versus the concentration. To rule out accidental errors in the formulations the amounts of K-PFBS (C. Examples 1, 2 and 3) were analyzed using X-ray. The results are shown in FIG. 1.

The analysis clearly shows a steady increase in the amount of potassium in the samples, consistent with the formulation. The optical properties show a decrease with increasing concentration. Even at the relatively low level of 0.08% by weight, the haze value is 3.8%, which is well above the value of 1%, which is considered low haze. Examples 6 to 10 show that the Oxygen Index increases with the amount of flame retardant salt, while the haze remains at a very low level of 0.4%. Without wishing to be bound by theory it is speculated that the cause of the variation in Oxygen Index with concentration in the KPFBS samples is due to a lack of dispersion. This may lead to local agglomerates of the flame retardant salt in the matrix and thereby locally varying Oxygen Index. The same may explain why the composition shows significant haze. Agglomerates of the flame retardant salt of sufficient size (100-800 nm) may scatter incident light, thereby creating haze. It seems that the lithium containing flame retardant salt is more compatible with the polycarbonate matrix and therefore gives a more consistent flame retardant performance and a lower haze. Examples 6 to 10 further show that the lithium salt seems to cause some initial degradation of the polycarbonate. If this effect is undesirable it is possible to compensate by using a polycarbonate with a higher molecular weight. Alternatively one can add stabilizers, such as phosphorous acid or butyl tosylate.

Table 3 shows compositions of the polycarbonate, the lithium containing flame retardant additive, and phosphorous acid as acid stabilizer. It is evident that the addition of a small amount of phosphorous acid prevents the earlier observed degradation.

FIG. 2 shows two injection molded articles. The left side of FIG. 2 shows an article made from a composition containing potassium perfluorobutane sulfonate (formulation according to comparative example 5), the right side of FIG. 2 shows an article made from a composition containing the lithium salt (formulation according to example 10). Bubbles are clearly observed in the article made with the K-PFBS whereas the same article made with a composition of the invention is completely clear.

The singular forms “a,” “an,” and “the” include plural referents unless the context clearly dictates otherwise. The endpoints of all ranges reciting the same characteristic are combinable and inclusive of the recited endpoint. All references are incorporated herein by reference.

While typical embodiments have been set forth for the purpose of illustration, the foregoing descriptions should not be deemed to be a limitation on the scope herein. Accordingly, various modifications, adaptations, and alternatives may occur to one skilled in the art without departing from the spirit and scope herein.

1. A composition comprising:
an aromatic polycarbonate resin and,
0.06% to 0.3% by weight of the total composition of a lithium containing flame retardant additive salt
wherein a molded test article prepared from the composition by injection molding, has a haze value less than about 1% as measured at a thickness of about 5.0 mm according to ASTM D1003 and wherein the composition is substantially chlorine and bromine free.

2. The composition of claim 1, wherein the article prepared from the composition has a haze value less than about 0.8% as measured at a thickness of about 5.0 mm according to ASTM D1003.

3. The composition of claim 1, wherein the article prepared from the composition has a haze value less than about 0.6% as measured at a thickness of about 5.0 mm according to ASTM D1003.

4. The composition of claim 1, wherein the flame retardant additive salt is a lithium perfluoroalkane sulfonate

5. The composition of claim 1, wherein the flame retardant salt is present at an amount such that the article prepared from the composition has an oxygen index greater than about 34 as measured according to ISO4589-2.

6. The composition of claim 1, wherein the flame retardant salt is present at an amount such that the article prepared from the composition has an oxygen index greater than about 35 as measured according to IS)4589-2.

7. The composition of claim 1, wherein the flame retardant salt is present at an amount such that the article prepared from the composition has an oxygen index greater than about 35.5 as measured according to ISO4589-2.

8. The composition of claim 1, wherein the flame retardant salt is lithium perfluorobutane sulfonate

9. The composition of claim 1, wherein the flame retardant salt is present at an amount of 0.08 to 0.15% of the total composition.

10. The composition of claim 1 wherein the composition further comprises and acidic stabilizer

11. The composition of claim 10 wherein the acidic stabilizer is phosphorous acid or butyl tosylate

12. The composition of claim 10 wherein the acidic stabilizer is present at an amount of 3 to 10 ppm.

13. A composition consisting essentially of
A) 97.5 to 99.94% by weight of an aromatic polycarbonate resin,
B) 0.06 to 0.3% by weight of a lithium containing flame retardant salt and
C) 0 to 2.44% by weight of conventional additives selected from the group consisting of thermal stabilizers, antioxidants, UV stabilizers, colorants and release agents and
wherein the sum of A+B+C equals 100% by weight.

14. An article made from the composition of claim 1, wherein the article is produced by injection molding or compression molding, optionally followed by another shaping method.

15. An article made from the composition of claim 1, wherein the article is a sheet or film produced by extrusion.

16. A method of making a transparent flame retardant polycarbonate article comprising:
melt blending a composition comprising an aromatic polycarbonate resin and a lithium containing flame retardant additive salt, and
forming said composition into an article,
wherein said article has a haze value less than about 1% as measured at a thickness of about 5.0 mm according to ASTM D1003 and wherein the composition is substantially chlorine and bromine free.

17. The method according to claim 16 wherein the composition consists of an aromatic polycarbonate resin, a lithium containing flame retardant additive salt, and conventional additives selected from the group consisting of thermal stabilizers, antioxidants, UV stabilizers, colorants and release agents

18. The composition according to claim 15, wherein an article prepared from the composition has a haze value less than about 1% as measured at a thickness of about 5.0 mm according to ASTM D1003 and wherein the composition is substantially chlorine and bromine free.
